(19) United States
(12) Patent Application Publication
(10) Pub. No.: US 2026/0311015 A1
(43) Pub. Date: Oct. 8, 2026

(54) SYSTEMS AND METHODS FOR FABRICATION OF QUANTUM COMPUTING NETWORKS

(71) Applicant: Purdue Research Foundation, West Lafayette, IN (US)

(72) Inventor: Tillmann C. Kubis, West Lafayette, IN (US)

(73) Assignee: Purdue Research Foundation, West Lafayette, IN (US)

(21) Appl. No.: 19/481,852

(22) PCT Filed: May 10, 2024
(86) PCT No.: PCT/US2024/028721

§ 371 Date: Nov. 5, 2025

Related U.S. Application Data
(60) Provisional application No. 63/465,905, filed on May 12, 2023.

(51) Int. Cl. G06N 10/20; G06N 10/40; G06N 10/60

(52) U.S. Cl. CPC G06N 10/20; G06N 10/40; G06N 10/60

(57) ABSTRACT

A method of optimizing a network-based quantum computer includes coupling a plurality of contacts with a network of transport channels. The plurality of contacts includes at least one read-out contact and at least one electrostatic control contact, and each channel of the network of transport channels is coupled with a read-out contact and an electrostatic control contact. The at least one electrostatic control contact is operable to control an electric charge within the network of transport channels. The method further includes initiating an optimization algorithm coupled with the plurality of contacts to generate an optimal contact setting configuration for the plurality of contacts coupled with the network of transport channels. Additionally, the method includes adjusting the plurality of contacts according to optimal the contact setting configuration.

### CROSS-REFERENCE TO RELATED APPLICATIONS

This application is related to and claims the priority benefit of U.S. Provisional Patent Application No. 63/465,905, entitled “Systems and Methods for Fabrication of Quantum Computing Networks,” filed May 12, 2023, the contents of which are hereby incorporated by reference in their entirety into the present disclosure.

### TECHNICAL FIELD

The present disclosure in general relates to computers and, more particularly, the present disclosure relates to utilizing optimization algorithms and classical computers for the fabrication of quantum computing networks.

### BACKGROUND

This section introduces aspects that may help facilitate a better understanding of the disclosure. Accordingly, these statements are to be read in this light and are not to be understood as admissions about what is or is not prior art.

Quantum computing refers to the field of research related to computation systems that use quantum mechanical phenomena to manipulate data. These quantum mechanical phenomena, such as superposition and entanglement, do not have analogs in the world of classical computing, and thus cannot be implemented with classical computing devices.

More particularly, the principle of quantum superposition asserts that any two or more quantum states can be added together, i.e. superposed, to produce another valid quantum state, and that any quantum state can be represented as a sum of two or more other distinct states. The principle of quantum entanglement refers to groups of particles being generated or interacting in such a way that the state of one particle becomes intertwined with that of the others. Furthermore, the quantum state of each particle cannot be described independently. Instead, the quantum state is given for the group of entangled particles as a whole. Yet another example of quantum-mechanical phenomena is sometimes described as a “collapse” because it asserts that when we observe (measure) particles, we unavoidably change their properties in that, once observed, the particles cease to be in a state of superposition (i.e. by trying to ascertain anything about the particles, we collapse their state).

### SUMMARY

Most semiconductor-based quantum computation systems require a careful device setup and accurate device fabrication to ensure ideal control of the quantum bit states. The technology and improvements presented herein lift this burden from the engineers and scientists and in some instances utilizes the help of state-of-the-art classical computers during the quantum computer fabrication. Particularly, aspects of this disclosure describe the development and fabrication of quantum computational networks through the use of classical computers and optimization algorithms, for example, machine learning or an artificial intelligence.

Specifically, the present disclosure includes aspects which can include coupling a plurality of contacts with a network of transport channels. The plurality of contacts can include at least one read-out contact and at least one electrostatic control contact, and each channel of the network of transport channels can be coupled with a read-out contact and an electrostatic control contact. The at least one electrostatic control contact can be operable to control an electric charge within the network of transport channels. The method can further include initiating an optimization algorithm coupled with the plurality of contacts to generate an optimal contact setting configuration for the plurality of contacts coupled with the network of transport channels. Additionally, the method can include adjusting the plurality of contacts according to optimal the contact setting configuration.

In some aspects, the method can further include fabricating a network of transport channels configured to host a plurality of qubits. The network of transport channels can be configured to host at least one of flying qubits or a plurality of quantum dot-based qubits formed at intersections of two or more transport channels. In some embodiments, the transport channels can be formed by one-dimensional materials.

In some aspects, the optimization algorithm can be configured to identify a configuration of conducting and gate controlling contacts that gives optimal quantum computer performance. The optimization algorithm can include at least one of a machine learning algorithm, a self-optimization algorithm, or an artificial intelligence.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts a schematic of a semiconductor based flying qubit formed on a 2D material;

FIG. 2 depicts a schematic of a random network of carbon nanotubes, showing an enlarged portion of the random network of carbon nanotubes for clarity;

FIG. 3 depicts a schematic of a quantum dot formed on a one-dimensional transport channel between the crossing of that channel with two other channels;

FIG. 4 depicts a schematic of adjacent quantum dots of a ID transport channel network, showing the adjacent quantum dots can interact due to the Coulomb interaction of the electronic charges and/or via the overlap of quantum dot wave functions through the connecting channels;

FIG. 5 depicts a schematic of the network of FIG. 4, including a transport channel positioned between the quantum dot qubits;

FIG. 6A depicts a schematic of another 1D transport channel network, including read-out, power supply, and control contacts coupled with the network;

FIG. 6B depicts a cross-sectional view of a control contact, insulator, and network as taken along the cross-sectional line 6B-6B of FIG. 6A;

FIG. 7 depicts a graphical representation of the electronic density of states of four CNTs of a first experiment at a given energy when they couple;

FIG. 8 depicts a graphical representation of the electronic density of states of four CNTs of a second experiment at a given energy when they do not couple;

FIG. 9 depicts a graphical representation of one quantum dot state at the crossing of two CNTs;

FIG. 10 depicts a flowchart representation of one method of fabricating a quantum computer; and

FIG. 11 depicts one exemplary system for fabricating a network-based quantum computer.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Aspects of the technology described herein are based on the insight that regular or quasi-random systems of one-dimensional (1D) transport channels, flakes of two-dimensional (2D) materials, or even dot-like impurities in three-dimensional (3D) materials can host quantum bit states. These states can either be based on particle localization (e.g., with |0> and |1> being the two extreme cases of spatial wave function distributions) or based on particle flux (e.g., with |0> and |1> being extreme cases of propagation paths). Instead of optimizing the various host system with regard to reproducibility and perfect alignment of control systems and quantum bits (e.g., having electrostatic gates centered on top of quantum dots), aspects of the technology described herein allow the host system to fluctuate arbitrarily.

However, instead of the minimum set of control systems (e.g., electrostatic gates) that would be sufficient to control a perfectly fabricated host system, this technology can in some instances require attachment to as many control systems (e.g., electrostatic gates) on the host system as possible. Those configurations that maintain the best control over the quantum bits may be generated through the use of machine searching algorithms that run on a state-of-the-art classical computer. The search algorithms can be configured to run test-configurations on the host and control systems and measure the respective quantum bit switching performance and entanglement quality. As such, the best working control configuration that the computer identifies will typically be unique to the respective host system. More particularly, as the configuration of the host system is more unique, the less the fabrication is under control, and therefore a completely uncontrolled host system fabrication yields unique configurations for every individual system. For example, a host system that consists of a random network of carbon nanotubes may require a machine-intense search for the best electrostatic gate configuration to control the data (e.g., flying qubits). Instead, a regular network of carbon nanotubes that reproduces previously fabricated networks may not require any new machine search. Therefore, the old configurations can be reapplied on a newly fabricated regular network.

There is a significant variety of solid-state systems that can be used for quantum computation. They typically are spin based, charge based, or particle flux based. Each of those systems are based on carefully designed solid state devices, sometimes nanodevices, i.e., devices that are fabricated with critical length scales of a countable number of atoms.

Small length scales are sometimes favorable to reduce the risk of incoherent scattering of propagating particles (e.g., carriers, often electrons) with other particles in the system. Such interaction changes the phase information of the qubit carriers to unpredictable values, referred to as “decoherence,” which eventually makes it challenging or impossible to correctly interpret the qubit information. When decoherence does not interfere too much with the carriers' phase information, and as long as the carriers are part of a system with two states that can be interpreted as |0> and |1>, the carrier states can be uniquely interpreted as superpositions of |0> and |1> and serve as qubits. The interaction of those carriers with external fields and the coherent interference with other particles in other states enable the controlled and continuous switching of qubits between |0> and |1>.

A charge-qubit example for such a system can be a quantum dot. A quantum dot's ground state and first excited state can serve as |0> and |1> for an electron confined in that quantum dot. Given the different charge distribution for both states, they interact differently with the dot environment which allows for a controlled switch between the two states. A conductor in the vicinity of the dot will have a different conductivity depending on the quantum dot charge distribution, which in turn depends on the qubit state.

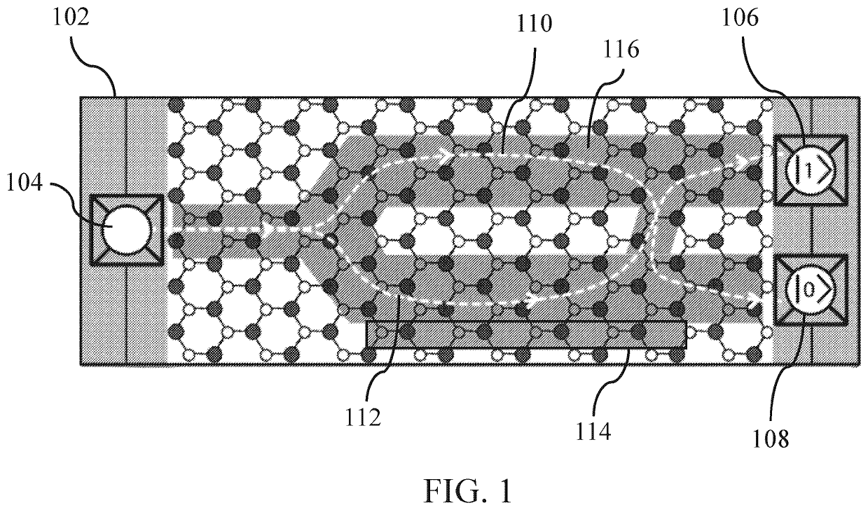

Flying qubits based on electrons is one practical example for a semiconductor-based flux qubit. As shown in FIG. 1, a semiconductor based flying qubit (102) has electrons enter from a source contact (104) and leave via two drain contacts (106, 108). Depending on the current ratio through the two drains, the system is in a superposition of qubits states |0> and |1>. The Aharonov-Bohm ring of two propagation paths (110, 112) the electrons have to pass through before reaching the drain (106, 108) causes self-interference that allows the tuning of the qubit's state superposition with a phase gate (114). Particularly, electrons entering from the source (104) pass effectively two beam splitters (shown with the bifurcating and crossing dashed arrows in FIG. 1) while propagating in the Aharonov-Bohm ring consisting of a double nanowire system, shown confined with electrostatic gates (116, illustrated as a darkened portion). The qubit state |1> is realized when the electron enters drain (106), while the qubit state |0> is realized when the electron enters drain (108). Superpositions of both configurations are controlled with the phase gate (114) at the lower nanowire.

When carriers of different qubits interact coherently (e.g., via the Coulomb interaction), their qubits typically cannot be described independently from each other, and the qubits become entangled. The maximum number of qubits that can be coherently entangled limits the maximum complexity of quantum algorithms the qubit system can perform.

Most often in quantum computers, particle states that coherently interact with the carriers of the qubits can be used to read out the qubit states. In the case of a charge qubit, conducting states in the vicinity of charge qubits are affected by the charge landscape of the qubit. Thus, depending on the qubit state of |0>, |1>, or superpositions of both, the conducting state maintains a certain amount of charge current. Thus, a conventional current density measurement can read the qubit state of specific qubits. Note that the flying qubit of FIG. 1 can be read either directly by either measuring the ratio of the two drain (106, 108) currents or by two conducting states in the vicinity of each drain (106, 108). The current through each drain (106, 108) then modifies the conductivity of each conducting state by either its charge density or the current induced magnetic moment. Thus eventually, measuring current density allows to read the qubit state of a flux qubit as well. Accordingly, one often important step in all quantum computing systems is to carefully design and fabricate a nanodevice that hosts a specific number of well-designed qubits.

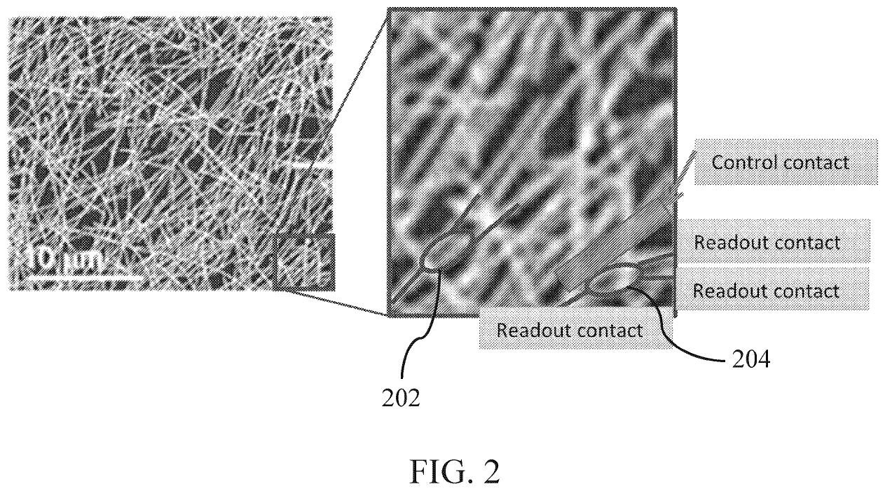

In the advantageous technology described herein, instead of carefully fabricating nanodevices to host a few well-designed qubits, a network of crossing transport channels may be created to allow for qubits to self-assemble. Detailed knowledge of the network's structure is therefore not necessary or required. Even random networks such as, for example, the random Carbon Nanotube (CNT) network shown in FIG. 2, are sufficient since a random CNT network will host a significant number of crossing 1D transport channels. When three or more channels cross, Aharonov-Bohm rings can form and flying qubit operation is possible. With reference to FIG. 2, two flying qubits (202, 204) are shown. One of the flying qubits (204) is in direct contact with readout contacts (as marked). One possible control contact (as marked) is positioned on top of the flying qubit (204) or otherwise in contact with the flying qubit (204).

While certain networks of transport channels are described herein, it should be understood that the network of transport channels may include any one of a network of nanotubes (e.g., carbon, Si, hBN etc.), a network of conducting nanowires, a network of conducting channels in a metal oxide framework, a network of conducting DNA molecules, conducting edge states of topological insulators, conducting edge states of flakes of two-dimensional materials, conducting edge states of nanocrystals or grains of three-dimensional materials, or insulating materials configured to isolate the network of transport channels from electrostatic contacts.

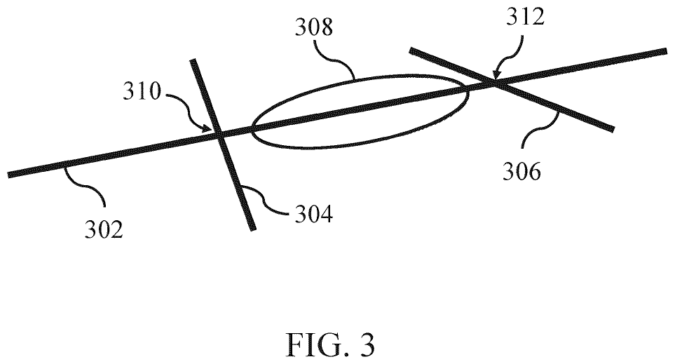

With reference to FIG. 3, the networks of 1D transport channels (302, 304, 306) can form a network of quantum dots (308). Whenever a transport channel (302, 304, 306) is in contact with another channel (302, 304, 306) (e.g., transport channel (302) crossing transport channel (304), or transport channel (302) crossing transport channel (306)), the potential landscapes at the crossing points (310, 312) differ from all other sections of the channels. Carriers propagating near such a crossing point (310, 312) have a finite probability to get reflected. When two such reflection points are on the same channel, a quantum dot, such as quantum dot (308), forms between the reflection points. Thereafter, two states of such a quantum dot (308) can serve as a qubit. Alternatively, any crossing point of 1D transport channels (310, 312) can host quantum dot states by itself as well.

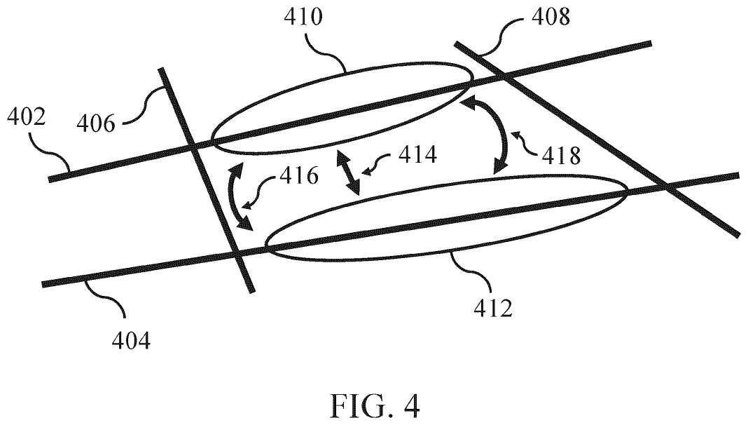

With reference to FIG. 4, a network of crossing 1D transport channels (402, 404, 406, 408), similar to the channels (302, 304, 306) shown in FIG. 3, can form a network of quantum dots (410, 412) and thus a network of single qubits by way of utilizing the quantum dots (410, 412). Coherent interaction between the quantum dots, for example, Coulomb interactions (414), wave function overlaps (416, 418), or other known interactions, can act to maintain an entanglement between the quantum dot qubits (410, 412).

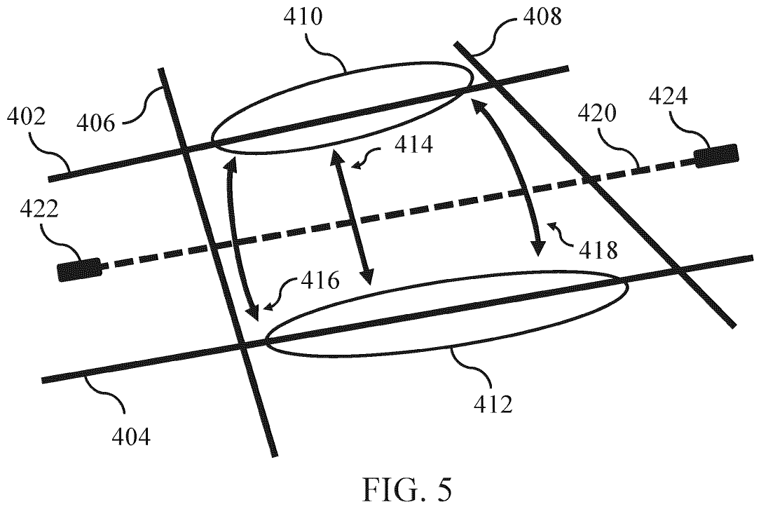

With reference to FIG. 5, if two interacting qubits (410, 412) are separated by one or more transport channels (420). The transport channel (420) may in some embodiments be positioned between the quantum dot qubits (410, 412) and can be selectively tuned to carry enough electrons to affect the interactions between the qubits (410, 412). More particularly, the charge in those channels (420) can be manipulated to screen the qubit-to-qubit (410, 412, respectively) interactions. Since that charge from the transport channel (420) is tunable with one or more contacts (422, 424), the effective entanglement between qubits is tunable as well.

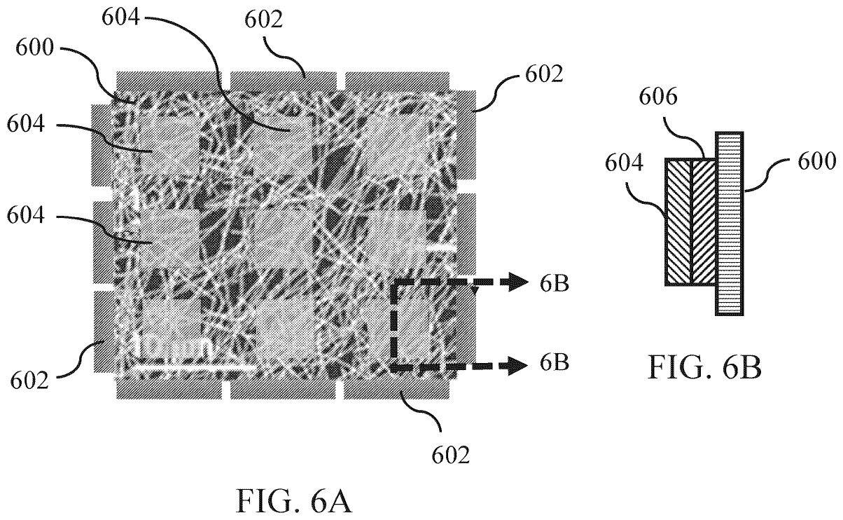

With reference to FIG. 6A, since the location and visibility of the qubits in a network of 1D transport channels may not be known in, for example, a random network of 1D transport channels (600), one step after the fabrication of the network is to have a conventional computer analyze the network (600) and search for the best visible qubits. To do so, the largest possible number of read-out and power supply contacts (602) has to be attached to the facets of the network (600). In some embodiments, each outward-facing 1D transport channel may have its own contact (602). In instances where the contacts are larger than the distance between adjacent 1D transport channels, several 1D transport channels may be in contact with the same contact (602).

In some embodiments, the read-out function of the read-out and power supply contacts (602) may be operable to generate a read-out signal of the properties of the network of transport channels including at least one of current density, electrostatic charge, charge capacity, magnetic field, electrostatic inductance, magnetic inductance, resistance, or transmittance. While a combined read-out and power supply contact (602) is described herein, it should be understood that in some embodiments the read-out and supply functions may be performed by separate contacts.

Those contacts (602) at the network facets can be configured and operable to supply the transport channels with electrons. Depending on the connectivity of the network and the specific bias setting of the contacts (602), current can be configured to flow through the network. Depending on the bias setting, this current can either supply electrons to the various qubits or read out the qubit states. As shown in FIG. 6B, the control contacts (604) may be separated from the network (600) via an insulating layer (606) disposed between the network (600) and the control contacts (604) to make sure the control contacts (604) only function to selectively change the qubit states, but do not read out from or supply charge to the network (600). For a given combination of readout and control contacts (604), one can change the voltage landscape of all contacts (604) and search for the performance pattern of a single qubit. Given the immense parameter space such a search has to work on, classical computers that are interfaced to both contact types can quickly ramp applied voltages and analyze the visibility of underlying qubits.

Once a list of single qubits are detected, a second search may be performed to combine the settings of two or more qubits and to test the dependence of the visibility of one or several qubits as a function of the state of one specific qubit. Accordingly, the more the single-qubit visibility is affected by the state of a selected qubit, the more that single-qubit is entangled with the selected one. Thus, the more the pair (or group) of qubits form a multi-qubit system. The machine search for triple qubit systems can either build on single-qubit lists or have the results of a double-qubit search input to a triple qubit search. As long as the qubit network is easy to interface with a classical computer, its search algorithms will find a good quantum computer setting (i.e., a working configuration of control contacts (604) and read-out/supply contacts (602)).

To make the network machine-learning ready, the qubits may be interfaced efficiently with the classical computer. All-electric readout may be preferable in some embodiments, but other means such as optical or magnetic readout that get later translated by the optical and magnetic sensors into electrical signals can serve this purpose as well. The interacting with the qubits (both readout and control) is preferred to be fast enough to allow for a rapid benchmarking of each configuration the search algorithm considers.

Qubits maintained by carriers in 1D transport channels have the advantage of limiting the scattering phase space of carriers to backward and forward scattering which is a significant reduction of scattering compared to the situation of carriers in 2D or 3D systems. However, surfaces or interfaces (e.g., in topological insulators, at grain surfaces of metals, on electric or magnetic domain boundaries of alloyed systems etc.) can form networks as well. For example, clusters of Germanium (Ge) atoms in silicon (Si) alloyed with Ge is one embodiment capable of hosting interface states. With sufficiently many Ge clusters close to each other, the interface states could interact and form a network. If those Ge atoms have a finite magnetic moment (e.g., in case of a nuclear moment of specific Ge isotopes), the interface states or states of the Ge-clusters themselves can host spin qubits.

Fluctuations of device fabrication do not feed into decoherence. Particularly, deviations from the desired device design and thus deviations from the expected qubit characteristic are not problematic since each device may be outfitted with its own machine-determined instructions on how to interpret it.

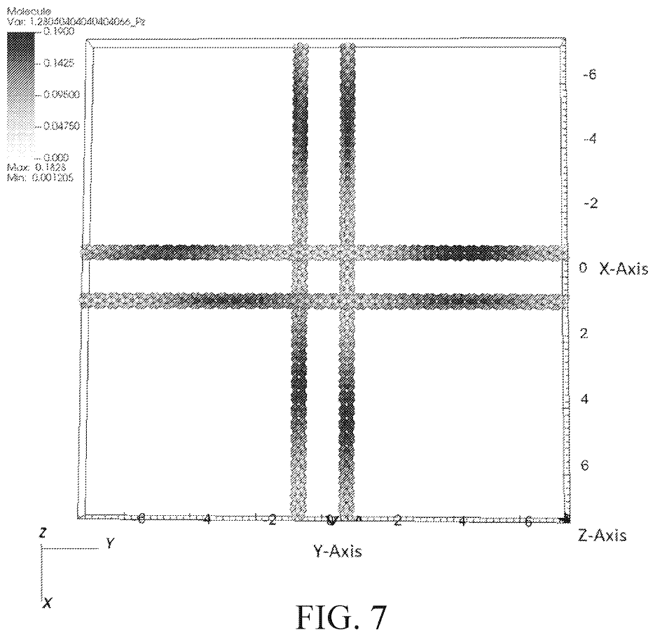

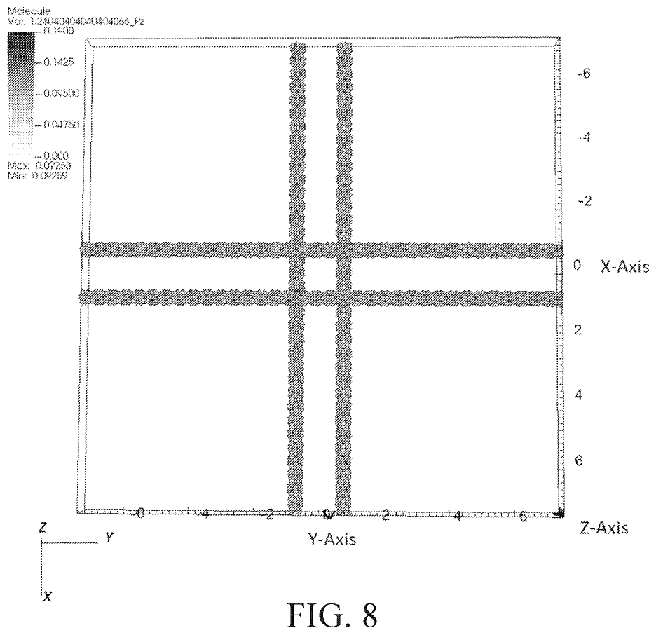

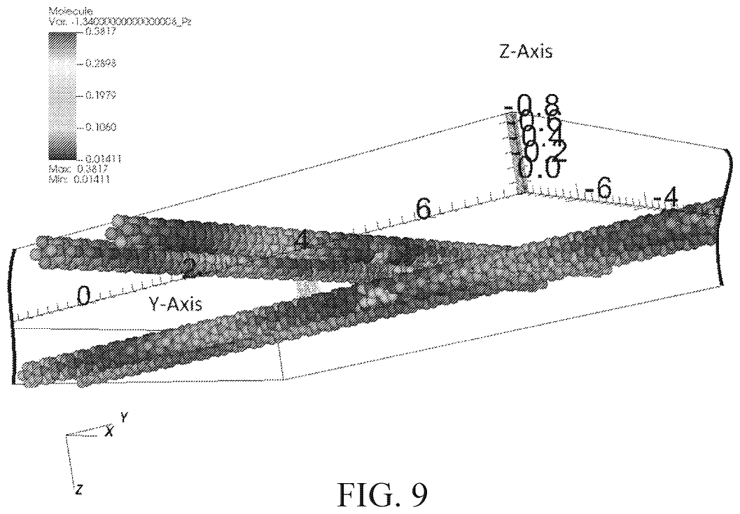

With reference to FIGS. 7-8, experimental quantum transport calculations confirm the formation of quantum dots at the crossings of CNTs. Particularly, FIG. 7 shows a graph of the electronic density of states of four CNTs at a given energy when they couple. FIG. 8 shows a graph of the electronic density of states of four CNTs at a given energy when they do not couple. As shown, the interaction between the four CNTs when they couple (see, FIG. 7) causes significant interference effects which are essential for operating quantum computing devices. The interference patterns shown indicate that CNT crossings can be used as an electrostatic Aharonov-Bohm ring. Thus, CNT crossings may be utilized as described herein to host “flying qubits.” FIG. 9 shows a quantum dot state at the crossing of two CNTs. Accordingly, as shown, quantum dots can be used to host qubits (“local” qubits in contrast to the flying ones).

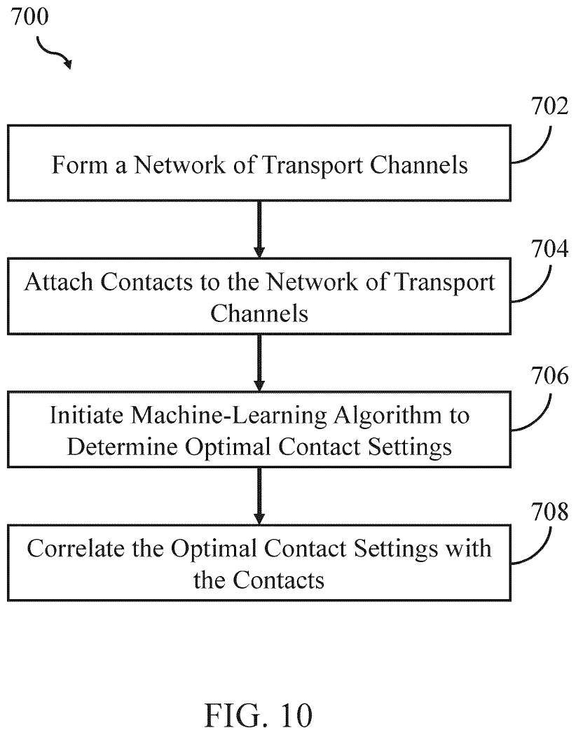

FIG. 10 shows one exemplary method (700) of fabricating a network-based quantum computer. At step (702), the method includes forming a network of transport channels, which in some embodiments may be a random mesh of 1D transport channels, that can host a plurality of qubits. In some embodiments, the plurality of qubits may be flying qubits or a plurality of quantum dot-based qubits, formed at the intersections of two or more 1D transport channels. At step (704), the method includes attaching a plurality of contacts to the network of transport channels. Particularly, each transport channel may be coupled with readout contacts and a plurality of contacts (e.g., electrostatic contacts) to control the charge landscape in the transport channel network. At step (706), optimization techniques or algorithms may be utilized to generate a collection of optimal contact settings for the unique configuration of transport channels and contacts from steps (702) and (704). Optimization algorithms may be utilized to determine which contacts shall be used as read-out/supply and/or control contacts, and which are not to be used at all. Optimization algorithms may include at least one of a machine learning algorithm, as self-optimization algorithm, or an artificial intelligence. Specifically, the optimal contact settings are those setting that are optimal for the most efficient operation of a quantum computer. At step (708), the method includes associating the best contact usage map, as determined at step (706), with the specific random network with contacts as configured at steps (702) and (704). Particularly, the ideal configuration of the contacts found should be stored or otherwise noted for that specific network of transport channels, such as by storing in a locally coupled memory device. Accordingly, one specific quantum computer is thereafter defined. Each step of method (700) may thereafter be iterated for each quantum computer being fabricated.

One example of a machine learning optimization algorithm includes (i) selecting a plurality of control and readout contact configurations; (ii) measuring the readout contacts' signals as a function of the voltages at the control contacts to gain performance data; (iii) analyzing the performance data into a qubit visibility number and assigning that to the plurality of control and readout contacts; (iv) iterating steps (i) through (iii) until a user defined number of visibility numbers is found that is higher than a user defined threshold; (v) the configurations of step (iv) are those single-qubits that were found with the best visibility; (vi) selecting a plurality of pairs of qubits of step (v); (vii) for each pair of the qubits of step (vi), measuring the readout contacts' signals as a function of the voltages at the control contacts to gain performance data; (viii) for each measurement of step (vii), analyzing the performance data of each of the pair of qubits into new qubit visibility numbers for each of the selected qubits; (ix) for each of the two single qubits in step (viii), the difference of the single-qubit and qubit-pair visibility numbers is a measurement for the qubit-qubit entanglement including (A) analyzing the performance of the qubits input to the computer via the interface, (B) controlling the voltages on the electrostatic and supply and read-out contacts and (C) selecting better supply and read-out and electrostatic contact configurations for a better performing quantum computer.

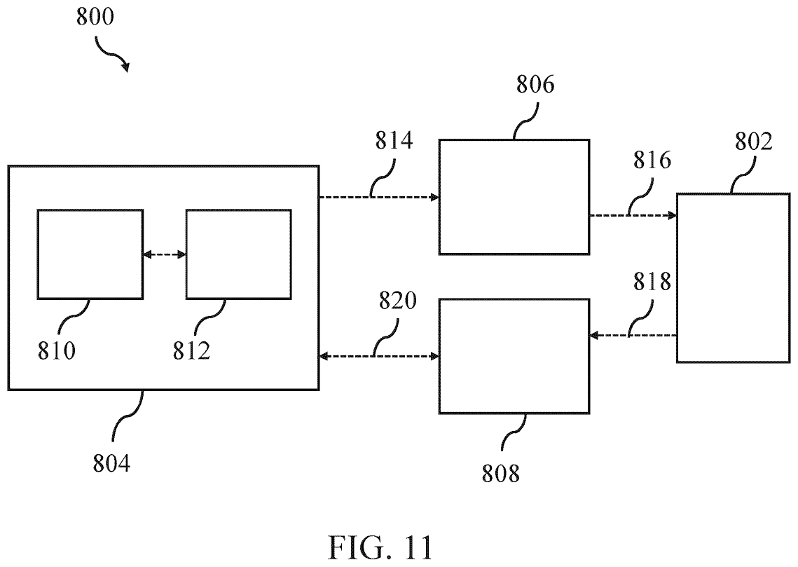

FIG. 11 shows one example of a system (800) configured to fabricate a network-based quantum computer (802) as described herein. As described above, the network-based quantum computer (802) includes at least one read-out contact (not shown) and at least one electrostatic control contact (not shown) coupled with a network of transport channels (not shown). As described above, each channel of the network of transport channels is coupled with a read-out contact and an electrostatic control contact, and the at least one electrostatic control contact is operable to control an electric charge within the network of transport channels, the system comprising. Particularly, the system can include various components such as a computer processing device (804), a first interface system (806), and a second interface system (808). The computer processing device (804) includes a data processor (810) configured to selectively initiate an optimization algorithm stored on a memory (812). Particularly, the computer processing device (804) is configured to generate an output signal (814) in response to initiating the optimization algorithm, wherein the output signal (814) includes an optimal contact setting configuration for the at least one read-out contact and at least one electrostatic control contact. The first interface system (806) is coupled with the computer processing device and configured to convert the output signal (814) into one or more voltages, wherein the first interface system is operable to apply the one or more voltages on the at least one read-out contact and at least one electrostatic control contact of the network-based quantum computer via connection (816). The second interface system (808) is configured to measure properties of the network of transport channels via connection (818) and input the measurements to the computer processing device via connection (820).

In some embodiments, the network of transport channels of the network-based quantum computer (802) may include at least one of a network of nanotubes, a network of conducting nanowires, a network of conducting channels in a metal oxide framework, a network of conducting DNA molecules, conducting edge states of topological insulators, conducting edge states of flakes of two-dimensional materials, conducting edge states of nanocrystals or grains of three-dimensional materials, or insulating materials configured to isolate the network of transport channels from electrostatic contacts.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/We claim:

1. A method of optimizing a network-based quantum computer, wherein the network-based quantum computer includes a network of transport channels that can host a plurality of qubits, the method comprising:
(a) coupling a plurality of contacts with the network of transport channels including at least one read-out contact and at least one electrostatic control contact, wherein each channel of the network of transport channels is coupled with a read-out contact and an electrostatic control contact, wherein the at least one electrostatic control contact is operable to control an electric charge within the network of transport channels;
(b) initiating an optimization algorithm coupled with the plurality of contacts to generate an optimal contact setting configuration for the plurality of contacts coupled with the network of transport channels; and
(c) adjusting the plurality of contacts according to optimal the contact setting configuration.

2. The method of claim 1, further comprising fabricating a network of transport channels configured to host a plurality of qubits.

3. The method of claim 2, wherein the network of transport channels is configured to host at least one of flying qubits or a plurality of quantum dot-based qubits formed at intersections of two or more transport channels.

4. The method of claim 2, wherein the transport channels are formed by one-dimensional materials.

5. The method of claim 1, wherein the optimization algorithm is configured to identify a configuration of conducting and gate controlling contacts that gives optimal quantum computer performance.

6. The method of claim 1, wherein the optimization algorithm includes at least one of a machine learning algorithm, a self-optimization algorithm, or an artificial intelligence.

7. The method of claim 1, wherein the optimization algorithm includes:
(i) selecting one electrostatic control contact and one read-out contact;
(ii) measuring a read-out contact signal from the at least one read-out contact as a function of a voltage at an electrostatic control contact to generate a first performance data set;
(iii) generating a qubit visibility number according to the first performance data set; and
(iv) assigning the qubit visibility number to the selected combination of the one electrostatic control contact and one read-out contact.

8. The method of claim 7, wherein the optimization algorithm further includes:
(v) iterating steps (i) through (iv) until a predefined amount of single qubits are located having visibility numbers higher than a predefined threshold, wherein the optimal contact setting configuration includes the predefined amount of single qubits.

9. The method of claim 8, wherein the optimization algorithm further includes:
(vi) selecting a plurality of pairs of the predefined amount of single qubits;
(vii) for each pair of the selected plurality of pairs of the predefined amount of single qubits, measuring read-out signals from a read-out contact as a function of a voltage at a control contact; and
(viii) generating a second performance data set corresponding to the measured read-out signals.

10. The method of claim 9, wherein the optimization algorithm further includes:
(ix) analyzing the set of second set of performance data of each pair of single qubits;
(x) generating a new qubit visibility number of each pair of single qubits according to the second set of performance data set.

11. The method of claim 10, wherein the difference of the single qubit and pair of single qubits visibility numbers is a measurement of a qubit-qubit entanglement, wherein the measurement of the qubit-qubit entanglement includes:
(A) analyzing the performance of an input of the single qubit to the computer via an interface;
(B) controlling the voltages on one electrostatic contact; and
(C) selecting a different read-out contact and electrostatic control contact configuration.

12. A system configured to fabricate a network-based quantum computer, wherein the network-based quantum computer includes at least one read-out contact and at least one electrostatic control contact coupled with a network of transport channels, wherein each channel of the network of transport channels is coupled with a read-out contact and an electrostatic control contact, wherein the at least one electrostatic control contact is operable to control an electric charge within the network of transport channels, the system comprising;
(a) a computer processing device having a data processor configured to selectively initiate an optimization algorithm stored on a memory, wherein the computer processing device is configured to generate an output signal in response to initiating the optimization algorithm, wherein the output signal includes an optimal contact setting configuration for the at least one read-out contact and at least one electrostatic control contact;
(b) a first interface system coupled with the computer processing device and configured to convert the output signal into one or more voltages, wherein the first interface system is operable to apply the one or more voltages on the at least one read-out contact and at least one electrostatic control contact; and
(c) a second interface system configured to measure properties of the network of transport channels and input the measurements to the computer processing device.

13. The system of claim 12, further comprising the network of transport channels, wherein the network of transport channels includes at least one of a network of nanotubes, a network of conducting nanowires, a network of conducting channels in a metal oxide framework, a network of conducting DNA molecules, conducting edge states of topological insulators, conducting edge states of flakes of two-dimensional materials, conducting edge states of nanocrystals or grains of three-dimensional materials, or insulating materials configured to isolate the network of transport channels from electrostatic contacts.

14. The system of claim 12, further comprising the network of transport channels, wherein the network of transport channels are formed by one-dimensional materials.

15. The system of claim 12, further comprising the network of transport channels, wherein the network of transport channels is configured to host at least one of flying qubits or a plurality of quantum dot-based qubits formed at intersections of two or more transport channels of the network of transport channels.

16. The system of claim 12, wherein the optimization algorithm includes at least one of a machine learning algorithm, a self-optimization algorithm, or an artificial intelligence.

17. The system of claim 12, further comprising at least one read-out contact, wherein the at least one read-out contact is operable to generate a read-out signal of the properties of the network of transport channels including at least one of current density, electrostatic charge, charge capacity, magnetic field, electrostatic inductance, magnetic inductance, resistance, or transmittance.

18. A network-based quantum computer, comprising:
(a) an interconnected network of quantum states;
(b) a plurality of first contacts configured to control
(i) a plurality of quantum states of the interconnected network of quantum states,
(ii) entanglement of the plurality of quantum states, and
(iii) interaction strength of the plurality of quantum states; and
(c) a plurality of second contacts configured to generate an output signal to read out the plurality of quantum states.

19. A network-based quantum computer of claim 18, wherein the interconnected network of quantum states includes at least one of:
(a) a network of nanotubes;
(b) a network of conducting nanowires;
(c) a network of conducting channels in a metal oxide framework;
(d) a network of conducting DNA molecules;
(e) conducting edge states of topological insulators;
(f) conducting edge states of flakes of two-dimensional materials; or
(g) conducting edge states of nanocrystals or grains of three-dimensional materials.

20. The network-based quantum computer of claim 18, wherein the plurality of first contacts include at least one electrostatic control contact, wherein the electrostatic control contact is operable to control an electric charge within the interconnected network of quantum states.
